(19) United States
(12) Patent Application Publication
(10) Pub. No.: US 2014/0104045 A1
(43) Pub. Date: Apr. 17, 2014

(54) REMOTE-CONTROLLING TECHNICAL PLANT

(71) Applicants: Joachim Häberlein, Neunkirchen A. Brand (DE); Torsten Rodat, Braunschweig (DE)

(72) Inventors: Joachim Häberlein, Neunkirchen A. Brand (DE); Torsten Rodat, Braunschweig (DE)

(73) Assignee: SIEMENS AKTIENGESELLSCHAFT, München (DE)

(21) Appl. No.: 14/126,773

(22) PCT Filed: May 29, 2012
(86) PCT No.: PCT/EP2012/059992

§ 371 Date: Dec. 16, 2013

(30) Foreign Application Priority Data
Jun. 14, 2011 (EP) 11169797.5

(51) Int. Cl. G08C 19/00

(52) U.S. Cl. CPC G08C 19/00
USPC 340/12.22

(57) ABSTRACT

A control system for a technical plant includes control units at the plant to control, maintain and/or monitor the technical plant as well as a management system outside the plant to remote-control, remotely maintain, and/or remotely monitor the technical plant. The control system further includes a data link between the management system and the control units, the control units being controllable and configurable by having the management system remotely access them.

### CROSS REFERENCE TO RELATED APPLICATIONS

This application is the U.S. national stage of International Application No. PCT/EP2012/059992, filed May 29, 2012 and claims the benefit thereof. The International Application claims the benefit of European Application No. 11169797 filed on Jun. 14, 2011, both applications are incorporated by reference herein in their entirety.

### BACKGROUND

Described below is a control system for a technical plant, a technical plant with such a control system and a method for controlling a technical plant.

With increasing technical possibilities, controllers of technical plants are also becoming increasingly more complex. Correspondingly qualified personnel are therefore required in order to be able to respond competently to malfunctions. The provision or rapid availability of such personnel is complicated and expensive.

US 2010/0277300 A1 discloses a platform for controlling safety, monitoring and automation functions, in particular for remotely monitoring and remote-control of home automation.

### SUMMARY

Described below is an improved control system for a technical plant and an improved method for controlling a technical plant.

A control system for a technical plant includes, on the plant side, i.e. in the area of the technical plant, control units for controlling, maintaining and/or monitoring the technical plant. Furthermore, the control system includes, external to the plant, i.e. outside of the technical plant, a management system for remote control, remotely maintaining and/or remotely monitoring the technical plant. The management system and the control units are connected by a data link, wherein the control units can be controlled and configured by remote access using the management system. Furthermore, the control system includes a first demilitarized zone, via which the data link is routed between the management system and the control units.

Demilitarized zones are understood to mean computer systems which shield the computer networks, using Firewall technology, against at least two other computer networks respectively and protect them from unauthorized accesses.

The control system thus allows for the control, maintenance and monitoring of a technical plant by remote access from the management system. As a result, savings in personnel can be made at the site of the technical plant or personnel need to be sent out less frequently to the technical plant. In cases in which personnel are however required at the site of the technical plant, the personnel can also be provided with qualified advice from plant-external specialists by way of the data link with the management system and assisted such that savings in highly qualified personnel can be made at the site of the technical plant. As a result, it is even possible to counteract a lack of skilled persons.

The remote monitoring, remote maintenance and remote control enables, by the management system, faults and exceptional operating states of the technical plant to be promptly identified and rapidly alleviated. Remote access to a technical plant is also advantageous in that the site from which access to the plant is provided is flexible and can in particular be changed, and also that the technical plant can be accessed from various locations.

The control system not only allows for the remote monitoring, remote maintenance and remote control of the technical plant in a predetermined status. Furthermore, it also allows for changes to the technical plant, by the control units themselves being configured by remote access. As a result, operating parameters of the technical plant can be advantageously updated or changing requirements can be adjusted via remote access.

Furthermore, status and performance data of the technical plant can be recorded, archived and evaluated by the management system. In particular, reports can be generated from such data at any time, for instance availability and usage statistics and information for service personnel.

By the first demilitarized zone, the data link between the management system and the technical plant and/or the control units is ensured, and in particular the management system is protected against unauthorized accesses.

In an embodiment, the control system includes at least one second demilitarized zone which is redundant with respect to the first demilitarized zone, via which the data link between the management system and the control units can be routed.

As a result, upon failure or unattainability of the first demilitarized zone, the data link can herewith be advantageously ensured by way of a second demilitarized zone. This advantageously increases the fail safety of the control system.

At least one control unit can be switched on and off by the management system.

This enables at least one control unit, for instance for maintenance purposes or for safety reasons, to be switched off and then subsequently on again via remote access. In particular, this allows for the installation or the replacement of firmware or system software of the control unit via remote access, if a new start of the control unit is required to this end.

Furthermore, firmware or system software or application software of at least one control unit can be installed, uninstalled and/or updated using the management system.

This allows essential functions of at least one control unit to be changed or extended by remote access and thereby advantageously increases the flexibility and performance of the control system.

The technical plant described below includes a control system and at least one actuator which can be actuated by way of a control unit of the control system and/or a sensor which can be read out by a control unit of the control system.

A technical plant of this type can be remote-controlled, remotely maintained and/or remotely monitored using the afore-cited advantages.

In particular, the technical plant may include a compensation plant for reducing an electrical reactive power.

As a result, the control system can in particular be used for remotely monitoring, remotely maintaining and remote control of the compensation plant and for improving the reduction in the electrical reactive power.

The method controls a technical plant using control units for its control, maintenance and/or monitoring, the control units are connected via a data link to a plant-external management system and the technical plant is remote-controlled, remotely maintained and/or remotely monitored by the management system, wherein the control units are controlled and configured by remote access by the management system. Here the data link is routed via a first demilitarized zone between the management system and the control units.

The data link may also be routed via a second demilitarized zone which is redundant relative to the first demilitarized zone, if the first demilitarized zone fails.

The advantages of the method correspond to the afore-cited advantages of the control system.

### BRIEF DESCRIPTION OF THE DRAWINGS

The afore-described properties, features and advantages and the manner in which they are achieved becomes clearer and more understandable in conjunction with the following description of exemplary embodiments, which are explained in more detail in conjunction with the drawings, in which:

FIG. 1 is a schematic representation of a control system for a technical plant, and

FIG. 2 is a schematic representation of a structure of remote control of a technical plant by a control system.

### DETAILED DESCRIPTION OF THE PREFERRED EMBODIMENT

Reference will now be made in detail to the preferred embodiments, examples of which are illustrated in the accompanying drawings, wherein parts which correspond to one another are provided with the same reference characters in the all of the figures.

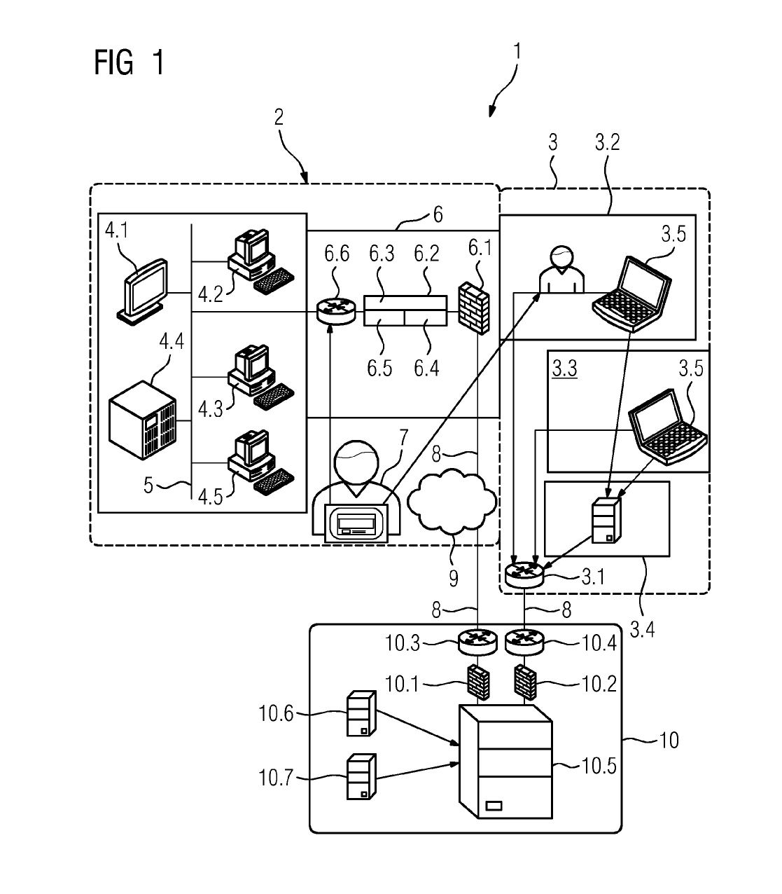

FIG. 1 shows a schematic representation of a control system 1 for a technical plant 2. The control system 1 is used to remote control, remotely maintain and/or remotely monitor the technical plant 2. To this end, it includes, on the plant side, for instance in a control room of the technical plant 2, control units 4.1 to 4.5 for controlling, maintaining or monitoring the technical plant 2 and external to the plant, a management system 3, i.e. a management system 3 which is disposed outside of the technical plant 2 and by way of which the technical plant 2 can be remotely controlled, remotely maintained and remotely monitored.

For instance, a first control unit 4.1 is a user interface for operating the technical plant 2, a second control unit 4.2 is a system interface for accessing system functions and changing system functions of the technical plant 2, a third control unit 4.3 is a sensor interface for collecting and forwarding sensor signals from sensors of the technical plant 2, a fourth control unit 4.4 is a memory-programmable controller and a fifth control unit 4.5 is a process data analysis unit for collecting and evaluating process data of the technical plant 2.

The control units 4.1 to 4.5 are networked via a plant-internal network 5 with components of the technical plant 2. The plant-internal network 5 is connected to a VPN interface 6 (Virtual Private Network), by way of which the plant-internal network 5 is accessed from the outside. The VPN interface 6 includes a first firewall 6.1, in the exemplary embodiment shown, a connecting device 6.2 with routing functions 6.3, VPN functions 6.4 and NAT functions 6.5 (NAT=Network Address Translation) and a first network component 6.6 with an interface, by way of which inter alia a user 7 can be connected to the plant-internal network 5.

The management system 3 is connected to the plant-internal network 5 by way of a data link 8. The data link 8 is routed via the internet 9 and a first demilitarized zone 10 arranged between the internet 9 and the management system 3. The inputs and outputs of the first demilitarized zone 10 to the internet 9 and the management system 3 are ensured by a second and/or third firewall 10.1 and 10.2 and are connected via a second and third network component 10.3, 10.4 to the internet 9 or the management system 3 via the data link 8. The first demilitarized zone 10 has a remote access platform 10.5, which enables and manages remote access to the technical plant 2, by it checking and managing authentication data for instance, assuming security functions such as a data encryption and decryption, recording and evaluating accesses and/or providing protocols for the data transmission. To this end, the remote access platform 10.5 has an access server 10.6 and a data server 10.7.

The management system 3 has a fourth network component 3.1, by way of which it is connected to the data link 8. In the exemplary embodiment shown, the management system 3 has a helpdesk 3.2 and a control platform 3.3, which in each case includes computing units 3.5, by which the technical plant 2 can be accessed by way of the data link 8 and the control units 4.1 to 4.5 for remote monitoring, remote maintenance and remote control purposes. Here accesses from an access portal 3.4 of the management system 3 are coordinated by protocols and programs.

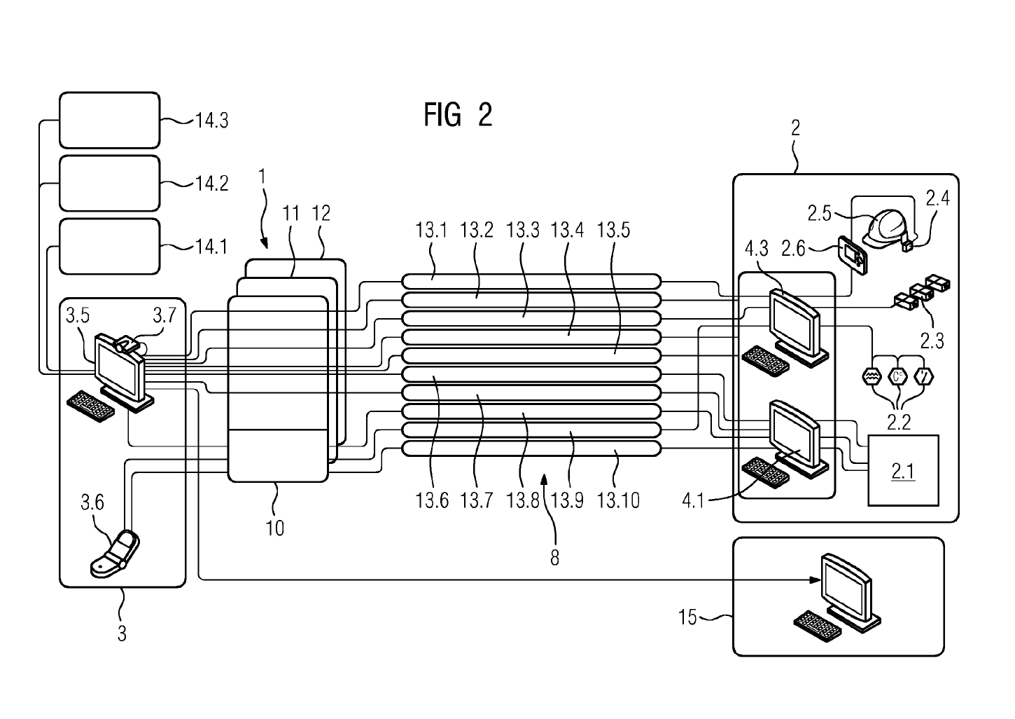

FIG. 2 shows a schematic representation of a structure of remote control of a technical plant 2 by a control system 1, as shown in FIG. 1.

In addition to the first demilitarized zone 10, the control system 1 includes two second demilitarized zones 11, 12 which are redundant relative to the first demilitarized zone 10, which can be located at sites other than the first demilitarized zone 10. If the first demilitarized zone 10 fails, the data link 8 is routed via one of these second demilitarized zones 11, 12. As a result, the fail safety of the data link 8 between the management system 3 and the technical plant 2 is increased.

The management system 3 is linked to various departments 14.1 to 14.3 of a business operating the control system 1, wherein a first department 14.1 is a virus competence center for fighting computer viruses, a second department 14.2 is product support and a third department is a development department 14.3. Information of these departments 14.1 to 14.3 for remote control, remote monitoring and remote maintenance of the technical plant can in this way be used advantageously, on the other hand the departments 14.1 to 14.3 can if necessary access the management system 3 and also the technical plant 2 themselves.

For remote control, remote monitoring and remote maintenance of the technical plant 2, the control system 1 provides various services 13.1 to 13.10 by way of the data link 8.

A first service 13.1 allows for an online link between the management system 3 and mobile devices, which can be carried around with them by technical personnel within the technical plant 2. Mobile devices of this type are for instance a mobile camera 2.4, the recordings of which are fed to the management system 3, and which is fastened for instance to a protective helmet 2.5, and a mobile communication device 2.6 with a display unit, on which information provided via the management system can be shown, for instance also camera images recorded by a webcam 3.5 of the management system 3. In this way, technical personnel of the technical plant equipped with mobile devices of this type can convey information directly to the management system 3 and can be assisted by the management system 3, for instance during maintenance or monitoring work.

A second service 13.2 enables the remote administration of the control units 4.1 to 4.5 from the management system 3. This includes in particular the remotely-controlled switch-on and switch-off capability of the control units 4.1 to 4.5 and the entirely remotely controlled access to basic-input-output systems (BIOS), network settings and operating systems of the control units 4.1 to 4.5.

A third service 13.3 allows for the transmission of multimedia data from the technical plant 2 to the management system 3, for instance the transmission of video recordings or camera images, which are recorded by monitoring cameras 2, 3 of the technical plant 2, and/or according to audio recordings.

A fourth service 13.4 allows for an updating of virus protection and application software for the control units 4.1 to 4.5.

A fifth service 13.5 allows for a modification of system and plant software of the control units 4.1 to 4.5.

A sixth service 13.6 allows for remote access to the control units 4.1 embodied as user interfaces.

A seventh service 13.7 allows for a composition of operating data of the technical plant 2. This service 13.7 can be expanded by an automatic generation of reports relating to the operation and status of the technical plant 2 and an automatic transmission of these reports to a collection point, for instance with a plant operator 15 of the technical plant 2.

An eighth service 13.8 allows for the transmission of warning signals of the technical plant 2, for instance of warning signals of a controller 2.1 of the technical plant 2 or a mobile communication device 2.6, to the management system 3.

A ninth service 13.9 allows for the transmission of measuring signals, which are detected by measuring sensors 2.2 of the technical plant 2, to the management system 3, about the technical plant 2. Measuring sensors 2.2 of this type may be for instance temperature, pressure or water sensors or also monitoring sensors for doors, windows or cabinets for instance.

A tenth service 13.10 allows for the transmission of error messages of the technical plant 2, for instance of error messages of a controller 2.1 of the technical plant 2, to the management system 3.

Particularly system-critical information from the technical plant 2, in particular warning signals of the eighth service 13.8, monitoring data of the ninth service 13.9 and error messages of the tenth service 13.10, may be sent here automatically via e-mail and/or SMS and/or telephone text messaging to service operators of the management system 3, for instance to a mobile telephone 3.6 of a service operator.

Although the invention was illustrated and described in detail by an exemplary embodiment, the invention is not restricted by the disclosed examples and other variations can be derived herefrom by the person skilled in the art without departing from the scope of protection of the invention as recited in the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A control system for a technical plant, comprising:
a management system external to the plant, at least one of remotely controlling, remotely maintaining and remotely monitoring the technical plant;
control units in the technical plant at least one of controlling, maintaining and monitoring the technical plant, the control units being controlled and configured by remote access by the management system; and
a data link connecting the management system and the control units and routed through a first demilitarized zone.

10. The control system as claimed in claim 9, wherein at least one second demilitarized zone exists which is redundant relative to the first demilitarized zone and via which the data link can be routed between the management system and the control units.

11. The control system as claimed in claim 10, wherein the management system switches at least one of the control units on and off.

12. The control system as claimed in claim 10, wherein the management system at least one of installs, un-installs and updates firmware or system software or application software of at least one of the control units.

13. A technical plant with a control system, comprising:
a management system external to the plant, at least one of remotely controlling, remotely maintaining and remotely monitoring the technical plant;
control units at least one of controlling, maintaining and monitoring the technical plant, the control units being controlled and configured by remote access by the management system;
a data link connecting the management system and the control units and routed through a first demilitarized zone; and
at least one of an actuator actuated by one of the control units and a sensor read by one of the control units.

14. The technical plant as claimed in claim 13, wherein the technical plant is a compensation plant reducing electrical reactive power.

15. The technical plant as claimed in claim 13, wherein at least one second demilitarized zone exists which is redundant relative to the first demilitarized zone and, via which the data link can be routed between the management system and the control units.

16. The technical plant as claimed in claim 15, wherein the management system switches at least one of the control units on and off.

17. The technical plant as claimed in claim 15, wherein the management system at least one of installs, un-installs and updates firmware or system software or application software of at least one of the control units.

18. A method for controlling a technical plant having control units performing at least one of control, maintenance and monitoring, the control units connected to a plant-external management system via a data link, comprising:
at least one of remotely controlling, remotely maintaining and remotely monitoring the technical plant by the management system; and
controlling and configuring the control units remotely by the management system via the data link which is routed via a first demilitarized zone between the management system and the control units.

19. A method as claimed in claim 18, further comprising routing the data link via a second demilitarized zone which is redundant relative to the first demilitarized zone, when the first demilitarized zone fails.
